(19) United States
(12) Patent Application Publication
(10) Pub. No.: US 2022/0350191 A1
(43) Pub. Date: Nov. 3, 2022

(54) SIDE-FASTENING AND EASY-ASSEMBLING DISPLAY PANEL

(71) Applicant: EBN Technology Corp., New Taipei City (TW)

(72) Inventors: CHIEN-LONG LIN, New Taipei City (TW); MING-JEN KUO, New Taipei City (TW)

(21) Appl. No.: 17/243,917

(22) Filed: Apr. 29, 2021

(51) Int. Cl. G02F 1/1333

(52) U.S. Cl. CPC G02F 1/133314; G02F 1/13332

(57) ABSTRACT

Disclosed is a side-fastening and easy-assembling display panel, and it mainly comprises: a display panel and a frame. The display panel is formed by a screen back face, a plurality of side edges, and a bottom face. The screen back face is disposed opposite to the bottom face, and the plurality of side edges are connected to the screen back face and the bottom face. The frame is an elastic body, and is formed by a plurality of elastic arms, a plurality of top portions, a plurality of notches, a bottom portion, and a wall body. The bottom portion is provided with an opening, to enclose and form a receiving space, to allow placing the display panel therein. The wall body of the frame covers the plurality of side edges of the display panel and a part of the screen back face.

### BACKGROUND OF THE INVENTION

### Field of the Invention

The preferred embodiment of the present invention relates to a display panel, and in particular to a side-fastening and easy-assembling display panel.

### The Prior Arts

In general, a Liquid Crystal Display (LCD) is a thin and planar type display device, on its screen is formed a plurality of color and black-and-white pixels, and the display device is placed in front of a light source or its back. The power consumption of the Liquid Crystal Display is rather low, thus it is welcomed and preferred by the consumers, and it is suitable to be used as an electronic device utilizing battery power supply. Usually, screws are used to fix the metal or plastic edge frame onto the display for buffering and protection. In application, the display device has to be made into the size required, while assembly tolerance must be reserved, and fixing piece such as screws must be used. As such, in addition to occupying space, the material and labor required could cause increase of production cost. Also, in certain cases, auxiliary material must be used as buffer between the display panel and other parts of the display device.

Therefore, presently, the design and performance of the Liquid Crystal Display is not quite satisfactory, and it leaves much room for improvements.

### SUMMARY OF THE INVENTION

In view of the problems and drawbacks of the prior art, the preferred embodiment of the present invention provides a side-fastening and easy-assembling display panel, to solve the shortcomings of the prior art.

The preferred embodiment of the present invention provides a side-fastening and easy-assembling display panel, and it mainly includes: a display panel and a frame.

Wherein, the display panel is provided with a screen back face, a plurality of side edges, and a bottom face. The screen back face is disposed opposite to the bottom face, and the plurality of side edges are connected to the screen back face and the bottom face. The frame is provided with a plurality of elastic arms, a plurality of top portions, a plurality of notches, a bottom portion, and a wall body. The bottom portion is provided with an opening, the wall body is connected to the bottom portion and the plurality of top portions. The wall body and the bottom portion are formed into a receiving space, for placing and receiving the display panel, and the wall body covers the plurality of side edges.

By way of the technical means mentioned above, in the present invention, through the characteristic of the elastic frame containing a plurality of elastic arms, a plurality of top portions, and a plurality of notches, the elastic frame can be bent, expanded, to contain and receive the display panel therein, hereby reducing the assembly tolerance, the material required, and the space occupied. Further, since the frame is of an elastic body, it is capable of achieving the effect of buffering and shock proof. Therefore, the side-fastening and easy-assembling display panel is able to eliminate and save the buffering auxiliary material, to achieve a compact structure and a simplified production process, in realizing light weight and low cost.

Further scope of the applicability of the present invention and given embodiments thereof will become apparent from the detailed descriptions hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

Embodiments of the present invention are described below, by way of example only, with reference to the accompanying drawings in which:

FIG. 1 is a schematic diagram of a side-fastening and easy-assembling display panel according to the present invention;

FIG. 2 is an exploded view of a side-fastening and easy-assembling display panel according to the present invention;

FIG. 3 is a partial enlarged view of a frame as shown in FIG. 2 according to the present invention; and

FIG. 4 is a side view of FIG. 2 according to the present invention.

### DETAILED DESCRIPTION OF THE PREFERRED EMBODIMENT

The purpose, construction, features, functions and advantages of the present invention and its embodiments can be appreciated and understood more thoroughly through the following detailed descriptions with reference to the attached drawings.

As shown in FIGS. 1 to 4, the present invention provides a side-fastening and easy-assembling display panel 100 to solve the problems and the shortcomings of the Prior Art, and it mainly includes: a display panel 1 and a frame 2.

Wherein, as shown in FIG. 1, the display panel 1 is provided with a screen back face 11, and a plurality of side edges 12, and a bottom face. The screen back face 11 is disposed opposite to the bottom face, and the plurality of side edges 12 are connected to the screen back face 11 and the bottom face.

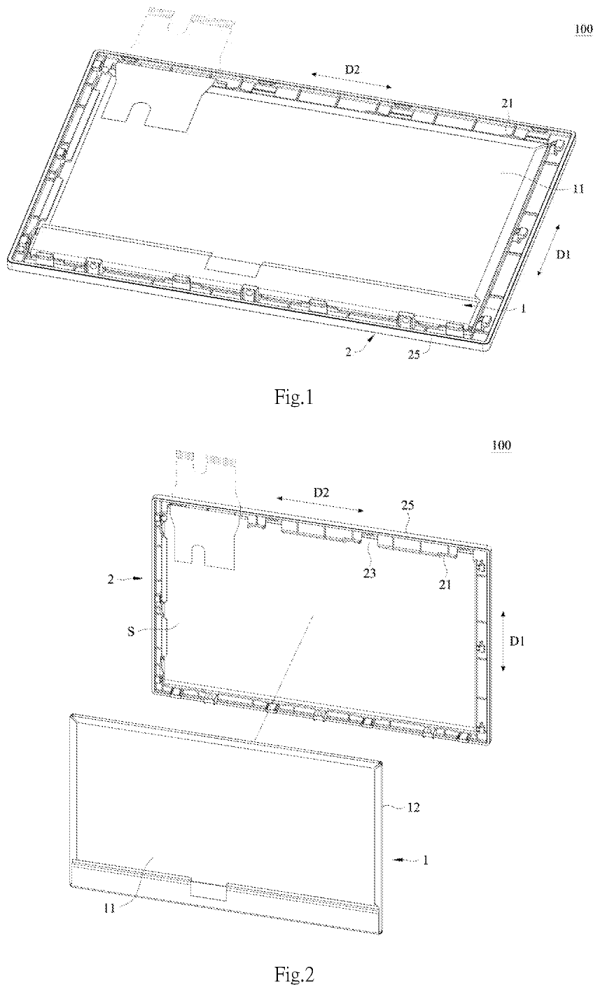

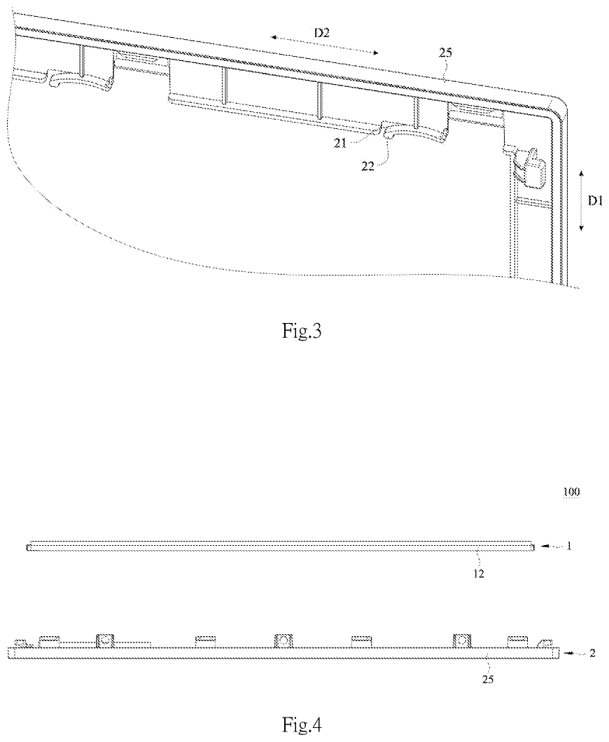

Further, as shown in FIGS. 2 and 3, the frame 2 is provided with a plurality of elastic arms 21, a plurality of top portions 22, a plurality of notches 23, a bottom portion, and a wall body 25. The frame 2 is of a rectangular shape, but the present invention is not limited to this. The bottom portion of the frame 2 is disposed an opening, to form into a receiving space S, such that the frame 2 is of a hollow shape, for the display panel 1 to place therein. The top portions 22 are disposed on the elastic arms 21 respectively, to be fastened to the display panel 1 securely through using a space reserved in the elastic arm 21.

The wall body 25 is connected to the bottom portion and a plurality of top portions 22, and the wall body 25 encloses the bottom portion to form a receiving space S for placing the display panel 1 therein. In an embodiment of the present invention, a plurality of elastic arms 21, a plurality of top portions 22, a plurality of notches 23, a bottom portion, and the wall body 25 are formed integrally into a body. The wall portion 25 is disposed around the outer perimeter of the bottom portion, while the wall body 25 covers the plurality of side edges 12. The plurality of top portions 22 is connected to a back side relative to the connection side of the wall body 25 and the bottom portion, and that can be disposed in the receiving space S. In an embodiment of the present invention, the plurality of top portions 22 are disposed on the wall body 25 with equal spacing, while in a section of the wall body 25, no top portion 22 is disposed.

By way of an example, in an embodiment of the present invention, the frame 2 is of a qradrilateral shape. On an upper or lower side of the wall body 25 is disposed a plurality of top portions 22. The length of the top portions 22 along direction D2 can be less than or equal to the length of the upper side or lower side of the wall body 25. Since the top portion 22 is disposed on the elastic arm 21, so the elastic arm 21 is disposed on the upper side or the lower side of the wall body 25.

As shown in FIG. 2, in an embodiment of the present invention, on an upper side of the wall body 25 is disposed in sequence the elastic arms 21 and the notches 23. The elastic arm 21 and the notch 23 are formed into a group, and the adjacent groups of the elastic arms 21 and the notches 23 are formed with equal spacing. On a left side of the wall body 25 is disposed the elastic arms 21 in sequence with equal spacing. In another embodiment of the present invention, on a lower side of the wall body 25 is disposed in sequence the elastic arms 21 and the notches 23. The elastic arm 21 and the notch 23 are formed into a group, and the adjacent groups of the elastic arms 21 and the notches 23 are formed with equal spacing. On a right side of the wall body 25 is disposed the elastic arms 21 in sequence with equal spacing. In the descriptions above, the elastic arm 21 is disposed closely adjacent to a side of the notch 23, and a spacing is formed between the groups formed by the elastic arms 21 and the notches 23, so that the side edges 12 of the display panel 1 can be fitted and fastened securely to the wall body 25. In the present invention, display panel 1 and the frame 2 are fitted in matching, to form a quadrilateral shape, but the present invention is not limited to this.

Further, the length of the side edge 12 of the display panel 1 vertical to the screen back face 11 can be less than the length of the receiving space S in the direction D1. The length of the side edge 12 of the screen back face 11 can be greater than or equal to the length of the receiving space S in the direction D2. Since the frame 2 is elastic, so it can be bent, expanded to place the display panel 1 therein, to realize the side-fastening and easy-assembling display panel 100.

In an embodiment of the present invention, a frame 2 formed by a plurality of elastic arms 21, a plurality of top portions 22, a plurality of notches 23, a bottom portion, and a wall body 25, is adapted to hold a display panel 1 formed by a screen back face 11, a plurality of side edges 12, and a bottom portion 13, to realize a side-fastening and easy-assembling display panel 100. Since the plurality of side edges 12 are covered by the frame 2 of elastic material, the frames 2 is able to provide buffer and protection for the display panel 1, to achieve the side-fastening and easy-assembling display panel 100 having buffer and protection capability. Therefore, the side-fastening and easy-assembling display panel 100 can be used as a display device, capable of providing backlight, support, and buffer functions. Further, in an embodiment of the present invention, the frame 2 could be of other shapes, and is not limited to the quadrilateral shape mentioned above.

Summing up the above, in the present invention, through the characteristic of the elastic frame containing a plurality of elastic arms, a plurality of top portions, and a plurality of notches, the elastic frame can be bent, expanded, to contain and receive the display panel therein, hereby reducing the assembly tolerance, the material required, and the space occupied. Further, since the frame is an elastic body, it is capable of achieving the effect of buffering and shock proof. Through the design of the present invention, the side-fastening and easy-assembling display panel is able to eliminate and save the buffering auxiliary material, to achieve a compact structure and a simplified production process, in realizing light weight and low cost.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A side-fastening and easy-assembling display panel, mainly comprising:
a display panel, provided with a screen back face, a plurality of side edges, and a bottom face, the screen back face is disposed opposite to the bottom face, and the plurality of side edges are connected to the screen back face and the bottom face; and
a frame, provided with a plurality of elastic arms, a plurality of top portions, a plurality of notches, a bottom portion, and a wall body, the bottom portion is provided with an opening, the wall body is connected to the bottom portion and the plurality of top portions, the wall body is formed into a receiving space with the bottom portion, the receiving space is used to place and receive the display panel, and the wall body covers the plurality of side edges.

2. The side-fastening and easy-assembling display panel as claimed in claim 1, wherein the top portions are disposed on the elastic arms respectively, to be fastened to the display panel through using a space reserved in the elastic arm.

3. The side-fastening and easy-assembling display panel as claimed in claim 1, wherein the elastic arm is disposed closely adjacent to a side of the notch.

4. The side-fastening and easy-assembling display panel as claimed in claim 3, wherein the elastic arms and the notches are disposed on a side of the wall body, the elastic arm and the notch are formed into a group, and the adjacent groups of the elastic arms and notches are formed with a spacing.

5. The side-fastening and easy-assembling display panel as claimed in claim 4, wherein on one side of the wall body is disposed the notches and the elastic arms, on the other side of the wall body is disposed at least one elastic arm, and two sides of the wall body are connected to each other.
